(19) United States
(12) Patent Application Publication
(10) Pub. No.: US 2017/0246485 A1
(43) Pub. Date: Aug. 31, 2017

(54) FIREFIGHTER PROTECTIVE GARMENT WITH REMOVABLE POUCHES

(71) Applicant: INNOTEX INC., Richmond (CA)

(72) Inventor: Claude BARBEAU, St-Bruno (CA)

(21) Appl. No.: 15/439,573

(22) Filed: Feb. 22, 2017

Related U.S. Application Data
(60) Provisional application No. 62/298,111, filed on Feb. 22, 2016.

(51) Int. Cl. A62B 17/00; A41D 27/20; A41D 1/06; A41D 3/00

(52) U.S. Cl. CPC A62B 17/003; A41D 3/00; A41D 27/201; A41D 1/06; A41D 13/0012

(57) ABSTRACT

A firefighter protective coat has at least one exterior pocket, and each of the at least one exterior pocket has an inside portion. The firefighter protective coat includes a linking element and a carrying element. The linking element has a proximal end and a distal end. The proximal end of the linking element is affixed to the inside portion of the at least one exterior pocket. The carrying element is affixed to the distal end of the linking element, and is sized to fit within the inside portion of the exterior pocket. The carrying element is from the inside portion of the exterior pocket to hang outside the at least one exterior pocket.

This application claims benefit of U.S. Provisional Patent Application Ser. No. 62/298,111, filed 22 Feb. 2016 and which application is incorporated herein by reference. To the extent appropriate, a claim of priority is made to the above disclosed application.

### TECHNICAL FIELD

The present invention relates to firefighter protective garments having pockets, and, more particularly, to a protective coat as worn by a firefighter or emergency medical technician.

### BACKGROUND

Firefighter protective garments such as coats and pants must meet rigorous standards in order to ensure the security of their wearers, as well as ideally provide comfort and support efficiently the tasks associated with firefighting functions.

Protective coats worn by firefighters generally include exterior pockets to carry personal protective equipment (PPE), such as gloves or goggles, as well as various other instruments or articles associated with the tasks of firefighting or emergency medical services.

Improvements of firefighter protective coat for better accessibility of the content of its pockets have been suggested.

For example, U.S. Pat. No. 8,701,218 B2 discloses a protective garment with hang-down pockets. The pockets are the principal exterior pockets of the garment and as such are large and voluminous. At least one of these exterior pockets is coupled to the front surface of the coat so as at least part of the pocket is located below the lower edge of the coat and is removably attached to the outside of the coat.

In another example, U.S. Pat. No. 6,976,273 B1 discloses a protective garment having a pocket within a pouch. The pouch is voluminous, and intended to carry a face mask of an SCBA. In the preferred embodiment of this invention, access to the face mask is possible via a zipper closure on the bottom of the pouch. There is a smaller pocket for carrying items such as a two-way radio within the pouch, accessible by a closure or flap at the top of the pouch.

In another example, U.S. Pat. No. 8,973,169 B2 discloses a protective garment with a modular storage system. The garment is equipped with a plurality of slits to which a variety of accessories can be removably attached.

Thus, it would be particularly useful to be able to provide an improved firefighter protective coat which, by virtue of its design and components, would be able to overcome or at least minimize some of the known drawbacks associated with conventional firefighter protective coats.

### SUMMARY

In accordance with one aspect, there is provided a firefighter protective coat. The firefighter protective coat has at least one exterior pocket and each of the at least one exterior pocket has an inside portion. The firefighter protective coat includes a linking element and a carrying element. The linking element has a proximal end and a distal end, and the proximal end of the linking element is affixed to the inside portion of the at least one exterior pocket. The carrying element is affixed to the distal end of the linking element, and is sized to fit within the inside portion of the exterior pocket. The carrying element is extractable from the inside portion of the at least one exterior pocket to hang outside the at least one exterior pocket.

In one embodiment, the carrying element is made of a material selected from the group consisting of: outer shell material, mesh material, webbing material, folded outer shell material with retroreflective trim attached, retroreflective trim, or a thereof.

In one embodiment, the carrying element is a pouch.

In another embodiment, the carrying element is a glove strap.

In one embodiment, the pouch includes at least one opening.

In one embodiment, the pouch is made of a mesh fabric.

In one embodiment, the linking element is a strap.

In one embodiment, the linking element includes a combined hook and loop fastener near the distal end that is engageable with the carrying element.

In one embodiment, the firefighter coat includes a releasable fastener. The releasable fastener connects the linking element to the inside portion of the at least one exterior pocket.

In one embodiment, the firefighter protective coat and the carrying element are made from materials meeting the performance requirements of The National Fire Protection Association standard NFPA 1971.

In one embodiment, the firefighter protective coat and the carrying element are made from materials meeting the performance requirements of NFPA 1999, Standard on Protective Clothing and Ensembles for Emergency Medical Operations.

In accordance with another aspect of the invention, there is provided a firefighter protective coat. The firefighter protective coat includes exterior pockets that are permanently attached to the outer shell of the firefighter protective coat. At least one of the exterior pockets comprises a pouch. The pouch is removably extractable from the at least one of the exterior pockets.

In one embodiment, the pouch is attachable to an inside of the at least one of the exterior pockets through a linking element.

In one embodiment, the linking element is selected from the group comprising straps, lanyards, chords and combined hook and loop fasteners.

In one embodiment, the linking element is sufficiently long for complete removal of the pouch from the pocket. The positioning of the pouch is such that it avoids interference with an accessory worn by the firefighter that restricts access to the pocket.

In one embodiment, the pouch includes at least one opening that is closeable with a closure assembly.

In one embodiment, the closure assembly is selected from the group comprising hook and loop closures, snap closures, zipper closures and drawstring closures.

In one embodiment, the pouch is constructed of a mesh fabric.

In one embodiment, the coat is made from materials meeting the performance requirements of The National Fire Protection Association standard NFPA 1971.

Other features and advantages of the present invention will be better understood upon a reading of embodiments thereof with reference to the appended drawings.

### BRIEF DESCRIPTION OF THE DRAWINGS

FIG. 1 is a representation of a front view of a firefighter protective garment, according to an embodiment of the invention.

FIGS. 2A and 2B are a representation of a linking element. FIG. 2A is an enlarged view of an exterior pocket containing an attachment device, in accordance with an embodiment of the invention. FIG. 2B is an enlarged view of one end of the linking element, in accordance with an embodiment of the invention.

### DETAILED DESCRIPTION

In the following description, similar features in the drawings have been given similar reference numerals. In order to not unduly encumber the figures, some elements may not be indicated on some figures if they were already mentioned in preceding figures. It should also be understood herein that the elements of the drawings are not necessarily drawn to scale and that the emphasis is instead being placed upon clearly illustrating the elements and structures of the present embodiments.

Protective coats worn by firefighters generally include exterior pockets to carry personal protective equipment (PPE), such as gloves or goggles, as well as various other instruments or articles associated with the tasks of firefighting or emergency medical services. However, access to the content of the pockets is sometimes limited or difficult, because the posture of the firefighter (e.g. when he firefighter is seating in a vehicle or wearing another piece of PPE, such as a harness, an equipment belt or an SCBA). More particularly, the straps or belts provided on PPE, when attached to the firefighter, may make it difficult, or even impossible to access and/or remove anything from the pockets.

As a result, firefighters often have to remove their gloves or any articles from the pockets of their coat before they actually need them. As a consequence, they will not have both hands free to perform their tasks. In some case, the firefighters may lose one or both gloves. Similarly, if the firefighters are wearing their SCBA or similar pieces of PPE, but no longer need to wear their protective gloves, they will not be able to stow their gloves in their pockets.

When the firefighters have access to the pockets of their protective coat, they may however be stowing inside the pockets gloves which are often wet, dirty and occasionally contaminated with biologically and/or chemically-hazardous materials, which may be damageable for the health of the firefighters.

The present invention generally relates to a firefighter protective coat having pouches within pockets for the purpose of holding small articles (e.g. gloves or goggles), and addressing some of the above-mentioned challenges.

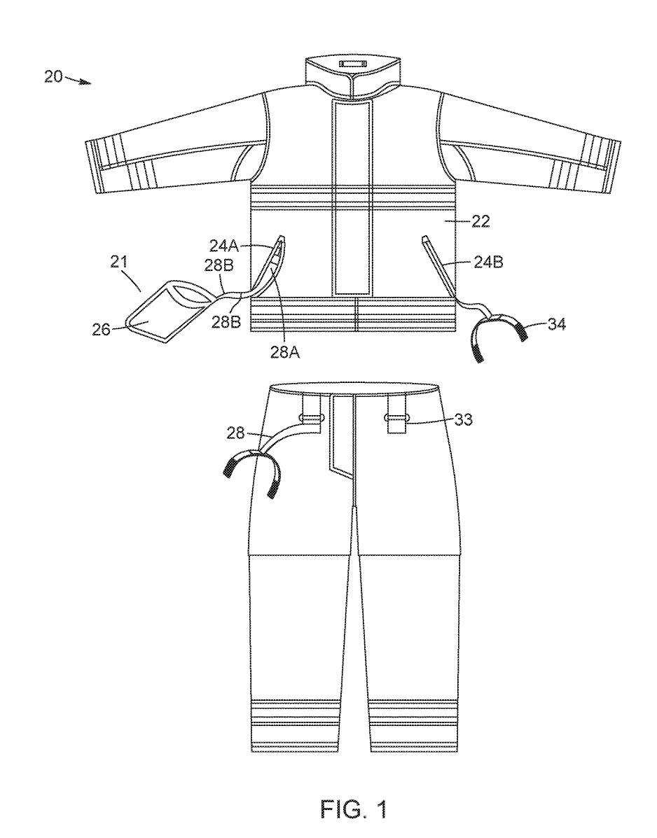

Referring to FIG. 1, there is shown a representation of a firefighter protective coat 20. The firefighter protective coat 20 typically includes an outer protective shell 22 made of a fire-resistant material, a moisture barrier (not shown in FIG. 1), a thermal barrier (not shown in FIG. 1) and/or a liner (not shown in FIG. 1). Optionally, the fire-resistant material may be a fabric of aramid fibers (sold under the trademark NOMEX®).

The firefighter protective coat 20 typically has at least one exterior pocket 24. The expression “exterior pocket” refers to a pocket whose contents can be accessed from the exterior of the coat. Each of the at least one exterior pocket 24 has an inside portion and is permanently attached to the outer shell 22. For example, the firefighter protective coat 20 may have two exterior pockets 24A, 24B. Optionally, the two exterior pockets 24A, 24B may be profiled pockets, i.e. pockets that are provided between the outer shell 22 and the liner of the firefighter protective coat 20. The profiled pockets have angled openings and are positioned (i.e. located) so as to allow for an easy access to their content (whether the firefighter is wearing a SCBA or not). For example, the profiled pockets may help reducing bulk when performing tasks associated with firefighting activities (e.g. bending, crawling, or rescuing people). The profiled pockets may also be useful, for example, for reducing snagging. Alternatively, the two exterior pockets 24A, 24B could be bellow pockets, fold-out pockets, padded pockets, gusseted pockets or combinations thereof. It will be understood that the type, size, number, and positioning of the at least one exterior pocket 24 may vary according to the need of one skilled in the art.

In some embodiments, the at least one pocket 24 may be made from a mesh material for improving air circulation of the firefighter protective coat 20 and/or the at least one pocket 24.

In one implementation, the at least one pocket 24 is provided with a closing mechanism 32, which will be described with greater details further below.

As illustrated, the firefighter protective coat 20 comprises a linking element 28. The linking element 28 may have a proximal end 28A and a distal end 28B. The proximal end 28A of the linking element 28 may be affixed to the inside portion of the at least one exterior pocket 24. For example, the proximal end 28A of the linking element 28 may be affixed to the inside portion of the at least one exterior pocket 24 with hook and loop, snap, stiches, combinations thereof, or any other means allowing the proximal end 28A to be permanently or removably affixed to the inside portion of the at least one exterior pocket 24.

In some implementations, the firefighter protective coat 20 may comprise a releasable fastener 30 connecting the linking element 28 to the inside portion of the at least one exterior pocket 24. Optionally, the linking element 28 may be a strap. Alternatively, the linking element 28 could be lanyards, chords and combined hook and loop fasteners. It will be understood that the linking element 28 may be embodied by any component having the required mechanical, thermal, and chemical properties (i.e. being at least flame-resistant).

In some embodiments, the linking element 28 may have an adjustable length and may further comprise a mechanism (not shown in the FIG. 1) for adjusting the adjustable length. Optionally, the adjustable length of the linking element 28 may be comprised between 6 and 16 inches.

In one implementation, the linking element 28 is approximately 16 inches long.

As illustrated, the firefighter protective coat 20 also comprises a carrying element 21. The carrying element 21 may be affixed to the distal end 28B of the linking element 28. The carrying element 21 is typically sized to fit within the inside portion of the at least one exterior pocket 24. The carrying element 21 may also be extractable from the inside portion of the at least one exterior pocket 24 to hang outside the at least one exterior pocket 24.

In some embodiments, the carrying element 21 may be a pouch 26. For example, and as illustrated in FIG. 1, the pouch 26 is attached to the inside of the exterior pocket 24A through the linking element 28.

In one implementation, the pouch 26 can be carried within the exterior pocket 24 and deployed only when necessary. Alternatively, the pouch 26 can freely hang from the exterior pocket 24A.

As described above, the pouches are typically attached to the inside portion of the at least one exterior pocket 24 via the linking element 28 near the proximal end 28A.

In one implementation, the pouch 26 (as an example of the carrying element 21) is sized, configured and positioned so that it can be removed from the at least one exterior pocket 24A and allowed to dangle sufficiently far from the at least one exterior pocket 24, such that the firefighter has access to the pouch irrespective of his posture, as it has been previously explained. For example, the dimensions of the pouch 26 may be 8.5 inches×11 inches.

In some embodiments, the pouch 26 may be made of a mesh fabric. The mesh fabric may be useful, for example, for allowing the pouch 26 or wet PPE contained within the pouch 26 to dry.

In some embodiments, the pouch 26 may be made of a material selected from the group consisting of: outer shell material, mesh material, webbing material, folded outer shell material with retroreflective trim attached, retroreflective trim. or a combination thereof. It will be readily understood that the pouch 26 is typically made from a relatively lightweight, fast-drying flame-resistant material.

In some embodiments, the linking element 28 may comprise a combined hook and loop fastener near the distal end 28B. For example, the combined hook and loop fastener may be engaged with the carrying element 21 (in the illustrated embodiment the pouch 26) and disengaged when needed.

In some embodiments, the pouch 26 may be closable and provided with closing assembly. For example, the closing assembly may comprise hook & loop fastener, a zipper, one or more snaps, a drawstring, combination thereof or any other means that allows the proper closure of the pouch 26.

In some embodiments, the carrying element 21 may be an attachment device 34. In some aspects, the attachment device 34 may be similar to the pouch 26. For example, and as illustrated in FIG. 1, the attachment device 34 is attached to the inside of the exterior pocket 24B through the linking element 28.

In one implementation, the attachment device 34 can be carried within the exterior pocket 24B and deployed only when necessary. Alternatively, the attachment device 34 can freely hang from the exterior pocket 24B.

Similarly to the pouch 26, the attachment device 34 is typically attached to the inside portion of the at least one exterior pocket 24 via the linking element 28 near the proximal end 28A.

In one implementation, the attachment device (as an example of the carrying element 21) is sized, configured and positioned so that it can be removed from the at least one exterior pocket 24 and allowed to dangle sufficiently far from the at least one exterior pocket 24, such that the firefighter has access to the pouch irrespective of his posture, as it has been previously explained.

In some embodiments, the attachment device 34 may be made of a mesh fabric. The mesh fabric may be useful, for example, for allowing the attachment device or wet PPE contained held by the attachment device 34 to dry.

In some embodiments, the attachment device 34 may be made of a material selected from the groups consisting of: outer shell material, mesh material, webbing material, folded outer shell material with retroreflective trim attached, retroreflective trim, or a combination thereof. It will be readily understood that the attachment device 34 is typically made from a relatively lightweight, fast-drying flame-resistant material, or, more generally, any other material having the required mechanical and thermal properties.

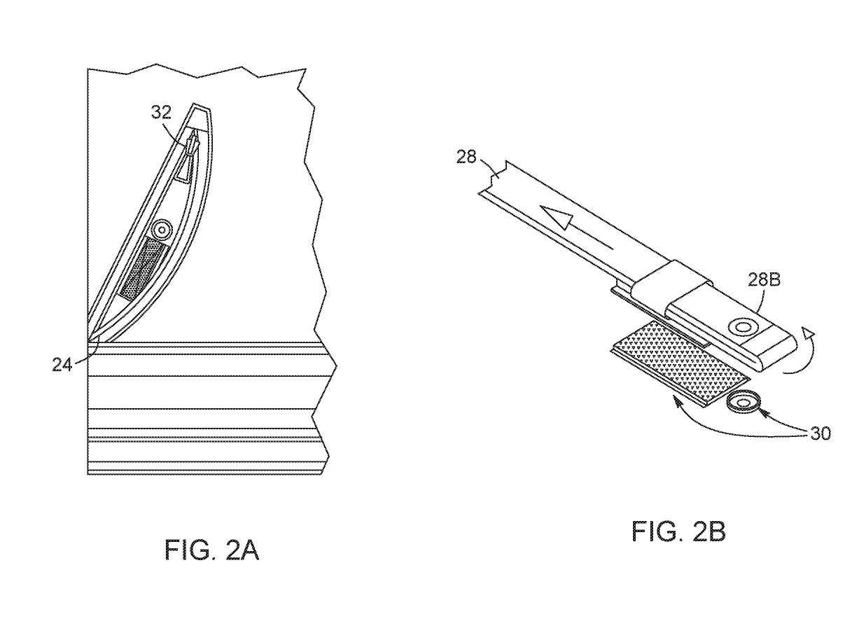

Now referring to FIG. 2A and FIG. 2B, the connection between the linking element 28 and the inside portion of the at least one exterior pocket 24 may be made with a releasable fastener 30. For example, the releasable fastener 30 may be embodied by hook & loop fasteners, snaps, quick-release buckle or any other means allowing the pouch 26 to be readily removed from (or attached to) the inside portion of the at least one exterior pocket 24.

In one implementation, the linking element 28 is a strap. The releasable fastener 30 is provided in the distal end 28B of the linking element 28 and comprises a hook-and-loop fastener and a snap button. When a sufficient amount of pull force is applied on the strap, the hook-and-loop fastener and the snap button may be released, hence allowing to detach the carrying element 21 (e.g. the pouch 26 or the attachment device 34) from the inside portion of the at least one exterior pocket 24.

In some embodiments, the opening of the at least one exterior pocket 24 which permits access to its contents is closable by a closing mechanism 32. For example, the closing mechanism 32 may comprise hook & loop fastener, a zipper, one or more snaps, a drawstring, combination thereof or any other means that allows the proper closure of the pocket.

In one implementation, the pouch 26 is attached to the inside portion of the at least one exterior pocket 24 and can either be stowed inside the at least one exterior pocket 24. In another implementation, the pouch 26 is allowed to hang outside the at least one exterior pocket 24.

In one implementation, the firefighter protective coat 20, the linking element 28, and the carrying element 21 (e.g. the pouch 26) are compliant with the National Fire Protection Association Standard on Protective Ensembles for Structural Fire Fighting and Proximity Fire Fighting. For example, the firefighter protective coat 20, the linking element 28, and the carrying element 21 may be made from materials meeting the performance requirements of The National Fire Protection Association standard NFPA 1971.

As described, some embodiments of the present invention may permit remote access and storing of the PPE in the pouch 26. The pouch 26 is removable (i.e. extractable) from the at least one exterior pocket 24. The present invention may then be useful, for example, in situations where a firefighter has to carry wet and/or contaminated gloves while wearing, for example, a piece of equipment which requires belts or straps. The present invention may prevent, for example, the straps of the SCBA (or another PPE belt) from blocking or restricting access to the contents of the at least one exterior pockets 24 of the firefighter protective coat 20. The present invention may be made of a material that would facilitate the airing or drying of its contents.

Although the present invention has been described as a removable carrying element to be attached to an inside portion of an exterior pocket of a firefighter protective coat, other means of carrying and storing PPE may additionally be provided on a firefighter garment in conjunction with the teachings of the present description. For example, a tab or any attachment device could be added to a firefighter pair of pants, in such a way that a pouch or any accessories can be attached to inside of a pocket on pair of pants by a linking element similar to that previously described. A pouch or other pieces of equipment, such as bag or belts to which access might be limited, may also be attached to other portions of the coat or pants without departing from the scope of the invention. By way of example, a tab may be provided on the garment to enable the installation of such accessories.

A first advantage of embodiments of the present invention is that it allows the wearer of the firefighter protective coat to readily have access to his gloves and/or other small articles, irrespective of his posture or whether he is wearing an SCBA, equipment belt or any pieces of equipment requiring straps.

A second advantage of embodiments of the present invention is the presence of small pouch(es) which can be carried within the exterior pocket and deployed only when necessary.

A third advantage of embodiments of the present invention is the design of the pouch. For example, the choice of the material from which the pouch is made (e.g. mesh material), may facilitate drying and airing of its contents.

A fourth advantage concerns the mechanical and thermal resistance of the pouch and the linking element. For example, the pouch and the linking element may resist thermal degradation following exposure to heat and flames encountered in firefighting environments.

A fifth advantage concerns the use of retroreflective and fluorescent material that may be provided on the linking element and/or the carrying element to make a firefighter more visible in low visibility areas, and which may facilitate finding a lost object that may have been inadvertently detached from the coat.

Of course, numerous modification could be made to the embodiments above without departing from the scope of the present invention.

1. A firefighter protective coat having at least one exterior pocket, each of the at least one exterior pocket having an inside portion, the firefighter protective coat comprising:
a linking element having a proximal end and a distal end, the proximal end of the linking element being affixed to the inside portion of the at least one exterior pocket; and
a carrying element affixed to the distal end of the linking element, the carrying element being sized to fit within the inside portion of the exterior pocket and extractable therefrom to hang outside the at least one exterior pocket.

2. The firefighter coat according to claim 1, wherein the carrying element is made of a material selected from the group consisting of: outer shell material, mesh material, webbing material, folded outer shell material with retroreflective trim attached, retroreflective trim. or a combination thereof.

3. The firefighter coat according to claim 1, wherein the carrying element is a glove strap.

4. The firefighter coat according to claim 1, wherein the carrying element is a pouch.

5. The firefighter coat according to claim 4, wherein the pouch is made of a mesh fabric or an outer shell material.

6. The firefighter coat according to claim 4, wherein the pouch comprises at least one opening.

7. The firefighter coat according to claim 1, wherein the linking element is a strap.

8. The firefighter coat according to claim 1, wherein the linking element comprises a combined hook and loop fastener near the distal end and engageable with the carrying element.

9. The firefighter coat according to claim 1, comprising a releasable fastener connecting the linking element to the inside portion of the at least one exterior pocket.

10. The firefighter coat according to claim 1, wherein the coat and the carrying element are made from materials meeting the performance requirements of The National Fire Protection Association standard NFPA 1971.
